(19) United States
(12) Patent Application Publication
(10) Pub. No.: US 2018/0268343 A1
(43) Pub. Date: Sep. 20, 2018

(54) VIRTUAL DIALOGUE CROWDSOURCING

(71) Applicant: INTERNATIONAL BUSINESS MACHINES CORPORATION, Armonk, NY (US)

(72) Inventors: Paul R. Bastide, Boxford, MA (US); Matthew E. Broomhall, Goffstown, NH (US); Robert E. Loredo, North Miami Beach, FL (US); Fang Lu, Billerica, MA (US)

(21) Appl. No.: 15/462,930

(22) Filed: Mar. 20, 2017

(51) Int. Cl. G06Q 10/06; G06F 17/30; G06Q 50/00

(52) U.S. Cl. CPC G06Q 10/063112; G06Q 50/01; G06F 17/30867

(57) ABSTRACT

A computer detects and identifies a consumer contacting a virtual dialogue host. The computer receives a query from the consumer and determines an estimated wait time to be connected to a representative. The computer determines whether additional information would be helpful in resolving the consumer query and, if so, requests that information. The computer proceeds to extract other information from the user during the remaining estimated wait time and aggregates the results.

### BACKGROUND

Crowdsourcing is a sourcing model in which many users contribute to achieve a cumulative result or goal. Typically, crowdsourcing increases reliability and decreases individual effort by determining a popular or reliable answer based on the inputs of many individual contributors. Often times, this involves disseminating nominal tasks to large amounts of individuals and aggregating the results to determine a best answer; for example, a survey or poll. Crowdsourcing is even more advantageous when these nominal tasks are part of a larger, complex problem which may be too time consuming or difficult for an individual. In such cases, the complex problem is broken down into nominal tasks which are more easily answered by the individuals to which it is disseminated. The set of diverse answers to the nominal task are then aggregated and combined to answer the complex problem with little individual effort and tremendous reliability.

### SUMMARY

Embodiments of the present invention disclose a method, system, and computer program product for crowdsourcing information. A computer detects and identifies a consumer contacting a virtual dialogue host. The computer receives a query from the consumer and determines an estimated wait time to be connected to a representative. The computer determines whether additional information would be helpful in resolving the consumer query and, if so, requests that information. The computer proceeds to extract other information from the user during the remaining estimated wait time and aggregates the results.

### BRIEF DESCRIPTION OF THE SEVERAL VIEWS OF THE DRAWING

FIG. 1 illustrates a crowdsourcing system 100, in accordance with an embodiment of the present invention.

FIG. 2 is a flowchart illustrating the operation of the crowdsourcing program 116 of FIG. 1 in extracting and crowdsourcing data from consumers during unused wait times of virtual dialogues.

FIG. 3 is a diagram graphically illustrating the hardware components of crowdsourcing system 100 of FIG. 1, in accordance with an embodiment of the invention.

FIG. 4 depicts a cloud computing environment according to an embodiment of the present invention.

FIG. 5 depicts abstraction model layers according to an embodiment of the present invention.

### DETAILED DESCRIPTION

Embodiments of the present invention will now be described in detail with reference to the accompanying figures.

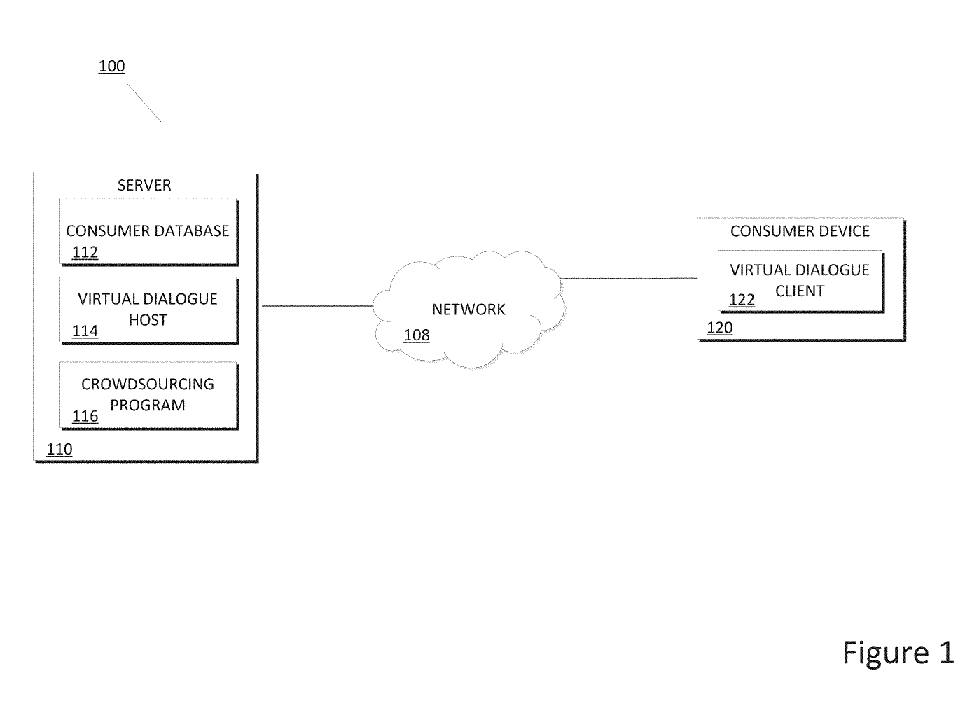

FIG. 1 illustrates a crowdsourcing system 100, in accordance with an embodiment of the invention. In the example embodiment, crowdsourcing system 100 includes server 110 and consumer device 120 connected via network 108.

In the example embodiment, network 108 is a communication channel capable of transferring data between connected devices. In the example embodiment, network 108 may be a telecommunications network used to facilitate telephone calls between two or more parties comprising a landline network, a wireless network, a closed network, a satellite network, or any combination thereof. In another embodiment, network 108 may be the Internet, representing a worldwide collection of networks and gateways to support communications between devices connected to the Internet. In this other embodiment, network 108 may include, for example, wired, wireless, or fiber optic connections which may be implemented as an intranet network, a local area network (LAN), a wide area network (WAN), or any combination thereof. In further embodiments, network 108 may be a Bluetooth network, a WiFi network, or a combination thereof. In general, network 108 can be any combination of connections and protocols that will support communications between server 110 and consumer device 120.

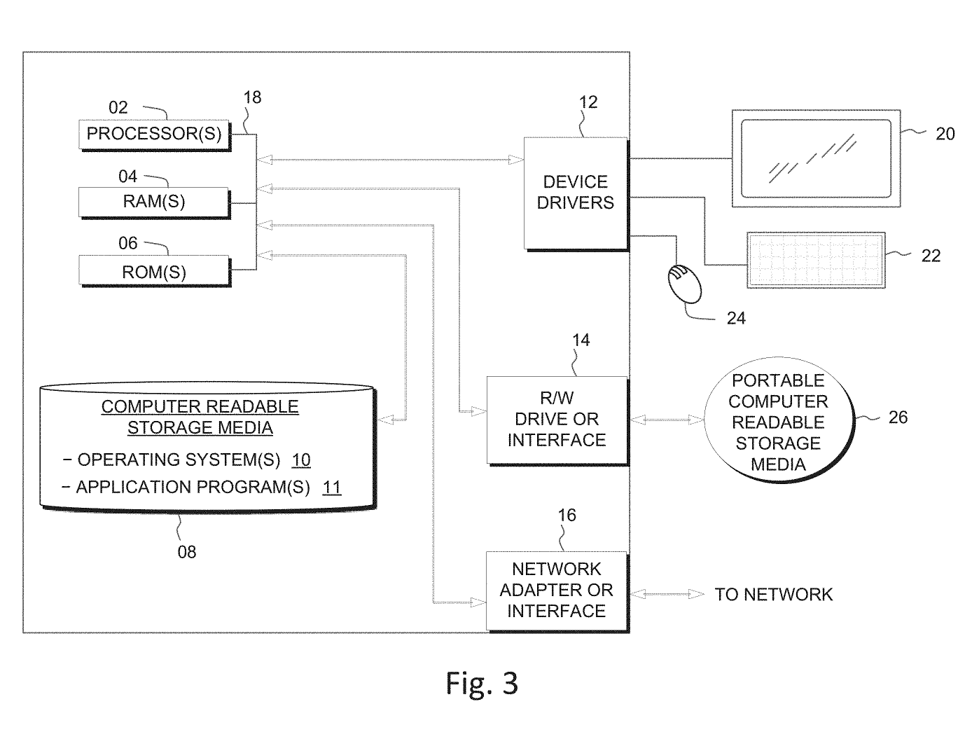

In the example embodiment, consumer device 120 includes virtual dialogue client 122 and may be a laptop computer, a notebook, a tablet computer, a netbook computer, a personal computer (PC), a desktop computer, a personal digital assistant (PDA), a rotary phone, a touchtone phone, a smart phone, a mobile phone, a virtual device, a thin client, or any other electronic device or computing system capable of receiving and sending data to and from other computing devices. While consumer device 120 is shown as a single device, in other embodiments, consumer device 120 may be comprised of a cluster or plurality of computing devices, working together or working separately. Consumer device 120 is described in more detail with reference to FIG. 3.

In the example embodiment, virtual dialogue client 122 provides a means for a user of consumer device 120 to interact with virtual dialogue host 114 as well as other virtual dialogue clients. In the example embodiment, virtual dialogue client 122 communicates with virtual dialogue host 114 via network 108 to transmit and receive audio, video, picture, and text communications as well as support file transfers, hyperlinks, and other data transfers. While in the example embodiment virtual dialogue client 122 is illustrated as standalone application, in other embodiments virtual dialogue client 122 may be accessed through or integrated with applications such as web browsers, telephone applications, chat applications, and video applications. Moreover, in some of these aforementioned embodiments, virtual dialogue client 122 may include a user interface comprising video displays, chat dialogues, participant lists, screen share capabilities, and other display components.

In the example embodiment, server 110 includes consumer database 112, virtual dialogue host 114, and crowdsourcing program 116. In the example embodiment, server 110 may be a laptop computer, a notebook, tablet computer, netbook computer, personal computer (PC), a desktop computer, a personal digital assistant (PDA), a smart phone, a thin client, or any other electronic device or computing system capable of receiving and sending data to and from other computing devices. While server 110 is shown as a single device, in other embodiments, server 110 may be comprised of a cluster or plurality of computing devices, working together or working separately. Server 110 is described in more detail with reference to FIG. 3.

In the example embodiment, consumer database 112 is an organized collection of data detailing one or more registered users. In the example embodiment, consumer database 112 details the consumers of a business or service provider and contains user information such as a user name, phone number, email address, physical address, date of birth, profession/expertise, educational merits, subscribed services/products, and other information pertinent to a business utilizing crowdsourcing program 116. In other embodiments, consumer database 112 may detail employees and contractors of a particular business or service provider. Overall, consumer database 112 details individuals associated with a business or service provider such that crowdsourcing program 116 (or virtual dialogue host 114) can readily identify users, be aware of general user and demographic information, be aware of purchased products and services, and maintain other records pertinent to the business or service provider hosting crowdsourcing program 116.

Virtual dialogue host 114 is a computer application programmed to autonomously respond to human voice or chat interaction, such as a virtual receptionist, automated attendant, interactive voice recognition (IVR) system, automated phone answering system, system greeting, chat bot, automated virtual chat agent, conference call host, voicemail manager, and any other virtual communication systems in which a computer is programmed to respond to human interaction. For example, virtual dialogue host 114 may be capable of performing tasks such as confirming a user identity, retrieving user information, directing a user to a particular department, providing a status of a product/service, indicating an estimated wait time, providing preloaded information, playing/deleting voicemails, and indicating how many consumers/participants are currently in a conference call. In the example embodiment, virtual dialogue host 114 communicates with virtual dialogue client 122 via network 108 and can transmit/receive audio, video, picture, and text communications as well as support file transfers, hyperlinks, and other data transfers. While in the example embodiment virtual dialogue host 114 is illustrated as a standalone application, in other embodiments virtual dialogue client 122 may be accessed through or integrated with other applications such as a web browser.

Crowdsourcing program 116 is a computer application programmed to extract and crowdsource data from users during wait times of virtual dialogues. In the example embodiment, crowdsourcing program 116 is integrated with virtual dialogue host 114 such that crowdsourcing program 116 may interact with consumers engaged in voice, chat, or other communications with virtual dialogue host 114. In other embodiments, however, crowdsourcing program 116 may be a standalone program which incorporates the capabilities of virtual dialogue host 114. In the example embodiment, crowdsourcing program 116 is capable of identifying a consumer and the expertise of the consumer. Moreover, crowdsourcing program 116 is capable of receiving a consumer query, determining an estimated wait time to resolve the query, and determining whether more information is necessary to resolve the query. In addition, crowdsourcing program is capable of extracting information from the identified consumer and aggregating the extracted information.

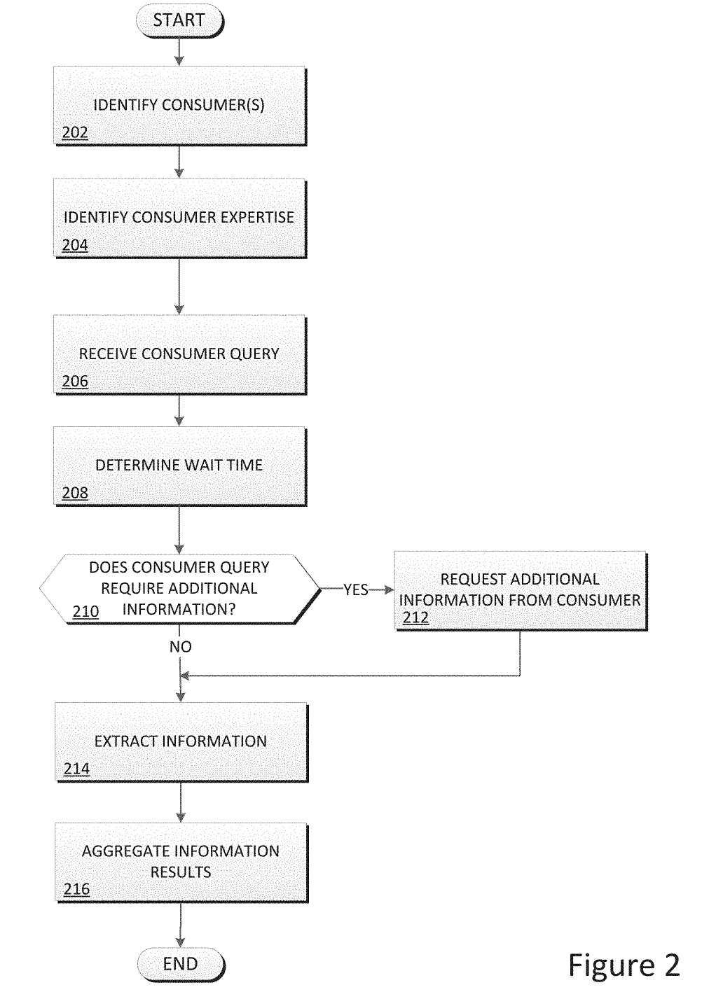

FIG. 2 is a flowchart depicting the operation of crowdsourcing program 116 in extracting and crowdsourcing data during wait times of virtual dialogues. As described in further detail below, crowdsourcing program 116 performs several steps in order to determine what information to extract and crowdsource from a consumer during the wait time of a virtual dialogue.

With reference to FIG. 2, crowdsourcing program 116 detects and identifies a consumer joining a virtual dialogue with virtual dialogue host 114 (step 202). In the example embodiment where crowdsourcing program 116 is integrated with virtual dialogue host 114, crowdsourcing program 116 detects that a consumer has joined a virtual dialogue by monitoring virtual dialogue host 114 for the initiation of a communication. Crowdsourcing program 116 then identifies a consumer by attempting to match the consumer with an existing consumer in consumer database 112. For example, in embodiments where crowdsourcing program 116 is implemented over a telephone, crowdsourcing program 116 determines whether a phone number associated with the communication corresponds to the phone number of a consumer detailed by consumer database 112. In embodiments where crowdsourcing program 116 is implemented over an internet, for example over a chat dialogue, crowdsourcing program 116 determines whether a username, account, internet protocol (IP) address, or media access control (MAC) address associated with communication corresponds to a consumer detailed by consumer database 112. If information associated with the communication indeed corresponds to a consumer detailed by consumer database 112, crowdsourcing program 116 may ask the user to confirm whether the corresponding identity is correct and optionally requests further verification via submission of confirmation information, such as the last four digits of a social security number, registered address, spouse, or other information indicative of the identity of the consumer. If, however, crowdsourcing program 116 cannot readily identify the identity of the consumer using the aforementioned methods of identification, crowdsourcing program 116 simply requests identification information from the consumer such as a name, account number, service address, etc. and verifies it against existing consumer records. In some embodiments, crowdsourcing program 116 may be configured to create new user accounts and/or update existing accounts within consumer database 112.

With reference now to an illustrative example, if a cable and internet company utilizes virtual dialogue host 114 to host consumer communications and consumer Alpha using consumer device 120 contacts the cable and internet company, then crowdsourcing program detects initiation of a communication with consumer Alpha and determines whether the phone number or MAC address corresponding to consumer device 120 matches any of the consumer records in consumer database 112. If, however, consumer device 120 does not match any existing records in consumer database 112, then crowdsourcing program 116 requests further identifying information from consumer Alpha.

Crowdsourcing program 116 determines an expertise of the identified consumer (step 204). As used herein, an expertise of the consumer indicates specialized knowledge of a particular subject and may be based off of a profession, education, passion, or hobby of the consumer. Identifying an expertise of the identified consumer is advantageous because crowdsourcing program 116 may then later extract information from the consumer with regard to the identified expertise. In the example embodiment, crowdsourcing program 116 determines an expertise of the identified consumer by referencing consumer database 112 wherein occupational or educational merits of the consumer are detailed. If consumer database 112 does not include information regarding the expertise of the consumer, crowdsourcing program 116 may reference other databases, such as online registries and social media, to determine an expertise of the consumer. For example, crowdsourcing program 116 may be configured to search for the consumer within a professional connections website in conjunction with local, state, and federal registries listing public/private certifications such as a bar membership, CPA certification, professional contracting license, medical license, and the like. If crowdsourcing program 116 is unable to identify the expertise of the consumer through social media or professional registries, crowdsourcing program 116 may simply prompt the consumer for an expertise or profession. Similar to above, upon identification of a expertise or profession, crowdsourcing program 116 may ask the user to confirm whether the corresponding expertise is correct and optionally requests further verification via submission of confirmation information.

With reference again to the illustrative example enumerated above where crowdsourcing program 116 identifies the consumer as Alpha, crowdsourcing program 116 references consumer database 112 to determine that Alpha has no associated professional or educational merits. Accordingly, crowdsourcing program 116 then extracts professional or educational merits from social media platforms and professional certification databases to determine that Alpha is a certified doctor.

Crowdsourcing program 116 receives a query from the detected consumer (step 206). In many of the aforementioned uses for virtual dialogue host 114, it is common for a consumer to have a problem, question, or concern which prompted initiation of the communication with virtual dialogue host 114. Often times, these queries require the consumer to wait on hold for a period of time, during which the invention described herein extracts query related or query unrelated information from the consumer. For example, virtual dialogue host 114 may receive a query regarding the purchase of a product or service and direct the consumer to the sales department where the consumer waits on hold temporarily. Similarly, virtual dialogue host 114 may receive a query regarding technical support and direct the consumer to a technical support help desk where the consumer waits on hold temporarily. During this temporary hold time while the consumer waits to have the query addressed is when crowdsourcing program 116 extracts information from the consumer through question and answer sessions. For example, additional information extracted from the consumer may include information necessary or helpful in resolving the received consumer query, information regarding the functional business area of the business utilizing virtual dialogue host 114, information regarding the identified expertise of the consumer, as well as general information unrelated to either the functional business area of the business or expertise of the user. Because of the limited time the consumer is on hold, crowdsourcing program 116 is configured to prioritize which information to first crowdsource in the available time. In the example embodiment, crowdsourcing program 116 is configured to prioritize extracting from the consumer information related to resolving the received consumer query prior to crowdsourcing information unrelated to the received query. In other embodiments, however, crowdsourcing program 116 may be configured to crowdsource information according to a different priority, as will become apparent in the proceeding paragraphs. Note that the consumer query is not to be confused with the questions utilized by crowdsourcing program 116 to crowdsource information from the consumer. As used herein, the consumer query corresponds to information sought by the consumer in contacting virtual dialogue host 114 while the crowdsourcing questions correspond to information sought by crowdsourcing program 116 while the consumer is on hold with virtual dialogue host 114. In the example embodiment, consumers submit a query via voice submission and crowdsourcing program 116 utilizes voice recognition in conjunction with natural language processing techniques to identify the query. Alternatively, the consumer may submit a query via text in the form of email, chat, file transfer, or other electronic media transfers which may then be extracted and processed by crowdsourcing program 116.

With reference again to the illustrative example above regarding Dr. Alpha contacting his cable and internet company, if Dr. Alpha states that he has no internet access, crowdsourcing program 116 utilizes voice recognition and natural language processing technology to identify a query describing an internet connectivity issue. Similarly, if Dr. Alpha types in a chat dialogue with virtual dialogue host 114 that channel 6 of his cable television is not working, then crowdsourcing program 116 references the chat dialogue code to extract and process the plain text of a query describing a television outage. In further embodiments where virtual dialogue host 114 hosts conference calls, queries and other data can be directed to either specific consumers/participants or all consumers/participants. For example, if Dr. Alpha is participating in a teleconference with other doctors and is seeking advice, Dr. Alpha may submit a spreadsheet of peculiar data, an x-ray, or thesis he has prepared. In this further embodiment in which virtual dialogue host 114 is hosting a teleconference, it is possible that some participants lack queries, in which case crowdsourcing program 116 simply omits step 206 for those particular consumers.

Crowdsourcing program 116 determines an estimated wait time for the consumer to be connected to a representative or other conference participants (step 208). In the example embodiment, crowdsourcing program 116 utilizes estimated wait times to determine how much data and what degree of difficulty of data can be extracted from the consumer. In other words, shorter wait times allow for extracting answers to a few concise and straight forward questions while extended wait times allow for extracting answers to many of the concise questions and/or more difficult or elaborate questions. In the example embodiment, wait times are calculated based on an amount of queries in the queue prior to the received consumer query and wait time models established through collecting and analyzing previous wait times. For example, wait times may be estimated based on the number of other consumers in a queue to have a query answered and the average time it takes to answer each query for a particular department. In further embodiments, wait times may be estimated based on more complex criteria, such as the nature of the queries in queue, efficiency of representatives assisting consumers, data trends based on time and day, and other criteria deduced from the collected data.

With reference again to the example above involving Dr. Alpha expressing internet connectivity issues, crowdsourcing program 116 determines that there is an estimated fifteen minute wait based on the amount of queries in the queue for the technical support help desk and the speed at which queries are resolved within the technical support department. In further embodiments in which virtual dialogue host 114 hosts conference calls, wait times may be calculated differently, for example via input by other consumers participating on the conference call, or this feature may simply be omitted. In this further embodiment where Dr. Alpha submits a spreadsheet of data for review by other participants in the teleconference, other doctors within the teleconference may, for example, simply input an estimated wait time corresponding to how long they expect it to take them to review the peculiar spreadsheet data.

Crowdsourcing program 116 determines whether the consumer query requires additional information helpful in resolving the query (decision 210). As described previously, information crowdsourced by crowdsourcing program 116 my include information related to the received customer query, information related to the functional business area of the business utilizing virtual dialogue host 114, information related to the expertise of the consumer, and the like. In the example embodiment, crowdsourcing program 116 is programmed such that resolving a consumer query takes priority over crowdsourcing other aforementioned information. Accordingly, crowdsourcing program 116 utilizes the estimated wait time to first determine whether more information regarding the query will aid a representative or virtual dialogue host 114 in resolving the received consumer query. In the example embodiment, crowdsourcing program 116 determines whether additional information would be helpful by comparing the identified query to a preprogrammed database of tree diagrams, flowcharts, and lists of criteria associated with common consumer queries. Similar to a troubleshooting guide, the preprogrammed database is configured to aid the user in troubleshooting and narrowing potential causes as well as identifying solutions to the consumer query. In other embodiments, however, crowdsourcing program 116 may be configured to crowdsource alternative information prior to retrieving additional information which may be helpful in resolving the consumer query.

If crowdsourcing program 116 determines that additional information would be helpful in resolving the received consumer query (decision 210 “YES” branch), crowdsourcing program 116 requests additional information from the consumer (step 212). In the example embodiment, crowdsourcing program 116 prompts the user for additional information based on the information corresponding to the consumer query in the preprogrammed database described above. In the example embodiment, consumers respond to the prompts for additional information utilizing a user interface of consumer device 120, such as actuating touchtone buttons manually, interacting with buttons on a screen of the device, or speaking into a microphone. Once crowdsourcing program 116 has exhausted the list of preprogrammed prompts for additional information and suggested actions or, alternatively, resolves the consumer query, crowdsourcing program 116 proceeds to extract alternative information unrelated to the consumer query with whatever time remains of the estimated wait time.

Continuing the example above illustrating Dr. Alpha contacting a cable and internet company to troubleshoot internet connectivity problems, crowdsourcing program 116 requests information regarding the consumers query, such as whether he has contacted the company regarding this issue before, whether has he reset his modem and/or router, how long the issue has persisted, whether he has installed any new software/hardware, and is there construction going on in or around his home.

If crowdsourcing program 116 determines that no additional information would be helpful in resolving the received consumer query (decision 210 “NO” branch), crowdsourcing program 116 proceeds to extract other information from the consumer with the remaining estimated wait time (step 214). In the example embodiment where crowdsourcing program 116 first retrieves information relative to the received consumer query, crowdsourcing program 116 then takes advantage of the remaining estimated wait time to extract information of interest from the consumer. In the example embodiment, the information extracted by crowdsourcing program 116 is first dependent on the available wait time before the consumer is connected to a representative or other consumers/participants in a conference call. With consideration of the remaining estimated wait time, crowdsourcing program 116 then extracts information based on the consumer expertise, the consumer query, and/or the nature of the business hosting crowdsourcing program 116. The aforementioned factors are weighed based on a configuration of the business hosting crowdsourcing program 116 to balance retrieving information necessary to resolve customer queries while simultaneously utilizing extra time to crowdsource information which the hosting company seeks.

As previously mentioned, while the example embodiment prioritizes extracting information relative to the consumer query prior to other information (refer to decision 210 and step 212 of FIG. 2), in other embodiments crowdsourcing program 116 may prioritize crowdsourcing information in an alternative order. For example, in another embodiment, crowdsourcing program 116 may prioritize extracting information relative to the functional business area of the business hosting virtual dialogue host 114 prior to information related to the consumer query (step 214 cont'd). Accordingly, in the example above, crowdsourcing program 116 may ask Dr. Alpha whether he would be interested in a faster rental router or whether he enjoys a particular program in the channel lineup to which he subscribes. In addition, crowdsourcing program 116 may reference the account of Dr. Alpha and ask that he pay his bill if he has not done so already. Moreover, crowdsourcing program 116 may adaptively transition to such questions from the previous topic, such as mentioning that a similar internet conductivity issue occurred on a popular television program prior to asking Dr. Alpha whether he regularly watches the program.

In other embodiments, crowdsourcing program 116 may prioritize crowdsourcing information regarding the professional or educational merits of the consumer (step 214 cont'd). Accordingly, in the example above, crowdsourcing program 116 may ask Dr. Alpha whether he believes a flu shot will prevent the flu, or what is the most effective exercise to lose weight. Again, crowdsourcing program 116 may be configured to seamlessly transition into such questions from previous questions, such as following up a question as to whether any utility lines are down outside with the question of what is the best outdoor exercise to lose weight or whether it is the appropriate season to get a flu shot.

In further embodiments in which virtual dialogue host 114 hosts conference calls or teleconferences, consumer queries may be disseminated to any or all of the participants taking part in the teleconference based on consumer preference (step 214 cont'd). Continuing the example above, Dr Alpha may request that all consumers participating in the medical teleconference review his peculiar spreadsheet data or thesis and provide feedback by filling out a survey or providing freehand notes.

In further embodiments, crowdsourcing program 116 may be configured to break down complex questions into manageable portions and disseminate the smaller portions to all consumers or multiple consumers of a particular education/professional merit (step 214 cont'd). In another example, multiple cooks may be asked how to prepare different portions of a meal to later consolidate the steps into a larger entre recipe or multicourse meal. Or, for example, multiple mechanics may be asked to describe how to perform smaller tasks which, when combined, comprise instructions on how to perform an oil change, swap a timing belt, or replace a transmission.

In other embodiments, crowdsourcing program 116 may be configured to extract information lucrative to another business or industry, such as implementing polls or surveys regarding overall consumer taste in music or politics (step 214 cont'd). Overall, crowdsourcing program 116 can be configured to extract any information desired by the host business, including mixing and matching embodiments exemplified herein.

Crowdsourcing program 116 aggregates the results of the extracted information (step 216). In the example embodiment, crowdsourcing program 116 may be configured to aggregate information on a person-by-person basis or consolidate information based on criteria such as age, gender, race, profession, or other distinguishing characteristics of interest. Moreover, information extracted from multi-part questionnaires or divided questions may be aggregated on a part-by-part basis or the most common answers may be aggregated into a single, multipart answer. Overall, crowdsourcing program 116 may be configured to manipulate and aggregate the extracted data in desirable configuration of the host.

FIG. 3 depicts a block diagram of components of server 110 and consumer device 120 of crowdsourcing system 100 of FIG. 1, in accordance with an embodiment of the present invention. It should be appreciated that FIG. 3 provides only an illustration of one implementation and does not imply any limitations with regard to the environments in which different embodiments may be implemented. Many modifications to the depicted environment may be made.

Server 110 may include one or more processors 02, one or more computer-readable RAMs 04, one or more computer-readable ROMs 06, one or more computer readable storage media 08, device drivers 12, read/write drive or interface 14, network adapter or interface 16, all interconnected over a communications fabric 18. Communications fabric 18 may be implemented with any architecture designed for passing data and/or control information between processors (such as microprocessors, communications and network processors, etc.), system memory, peripheral devices, and any other hardware components within a system.

One or more operating systems 10, and one or more application programs 11, for example, crowdsourcing program 116, are stored on one or more of the computer readable storage media 08 for execution by one or more of the processors 02 via one or more of the respective RAMs 04 (which typically include cache memory). In the illustrated embodiment, each of the computer readable storage media 08 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Server 110 may also include a R/W drive or interface 14 to read from and write to one or more portable computer readable storage media 26. Application programs 11 on server 110 may be stored on one or more of the portable computer readable storage media 26, read via the respective R/W drive or interface 14 and loaded into the respective computer readable storage media 08.

Server 110 may also include a network adapter or interface 16, such as a TCP/IP adapter card or wireless communication adapter (such as a 4G wireless communication adapter using OFDMA technology). Application programs 11 on server 110 may be downloaded to the computing device from an external computer or external storage device via a network (for example, the Internet, a local area network or other wide area network or wireless network) and network adapter or interface 16. From the network adapter or interface 16, the programs may be loaded onto computer readable storage media 08. The network may comprise copper wires, optical fibers, wireless transmission, routers, firewalls, switches, gateway computers and/or edge servers.

Server 110 may also include a display screen 20, a keyboard or keypad 22, and a computer mouse or touchpad 24. Device drivers 12 interface to display screen 20 for imaging, to keyboard or keypad 22, to computer mouse or touchpad 24, and/or to display screen 20 for pressure sensing of alphanumeric character entry and user selections. The device drivers 12, R/W drive or interface 14 and network adapter or interface 16 may comprise hardware and software (stored on computer readable storage media 08 and/or ROM 06).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Based on the foregoing, a computer system, method, and computer program product have been disclosed. However, numerous modifications and substitutions can be made without deviating from the scope of the present invention. Therefore, the present invention has been disclosed by way of example and not limitation.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

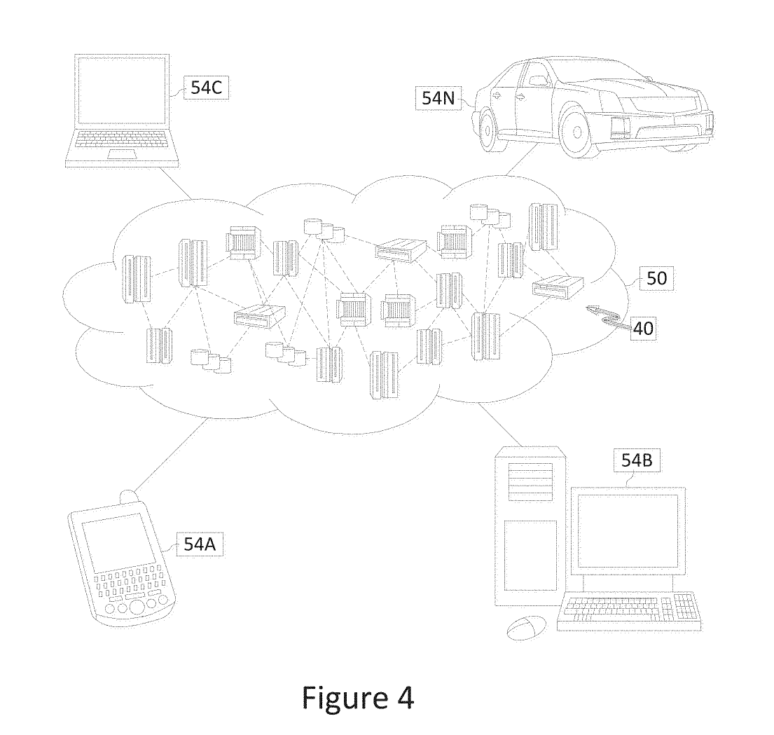

Referring now to FIG. 4, illustrative cloud computing environment 50 is depicted. As shown, cloud computing environment 50 includes one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 40 and cloud computing environment 50 can communicate with any type of computerized device over any type of network and/or network addressable connection (e.g., using a web browser).

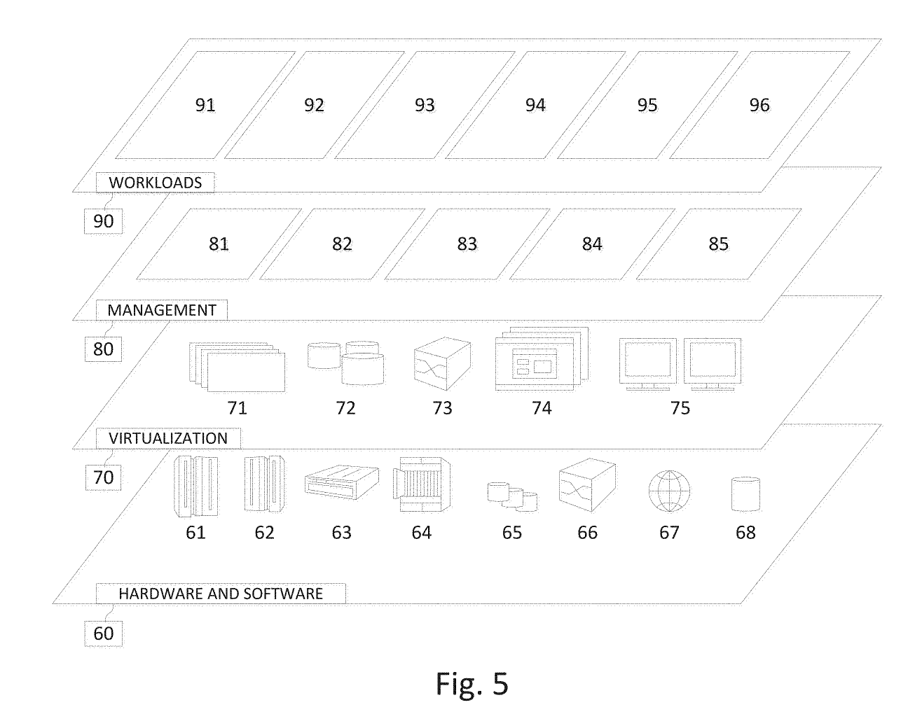

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and crowdsource processing 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method for crowdsourcing information, the method comprising:
detecting, by a computer, a user contacting a virtual dialogue host which autonomously responds to user interaction;
receiving, by the computer, a query from the user;
determining, by the computer, an estimated wait time to be connected to a representative;
determining, by the computer, a complexity of information to be extracted from the user based on the estimated wait time, wherein a greater estimated wait time is associated with extracted information having a greater complexity;
extracting, by the computer, the information from the user during the estimated wait time; and
aggregating, by the computer, the information extracted from the user.

2. The method of claim 1, further comprising:
identifying, by the computer, an expertise associated with the user, and wherein the extracted information is related to the identified expertise of the user.

3. The method of claim 1, further comprising:
requesting, by the computer, additional information from the user which is related to the received user query based on a preprogrammed database correlating one or more user queries with requisite additional information; and
receiving, by the computer, the additional information from the user.

4. The method of claim 1, wherein the extracted information is related to a functional business area of a company hosting the virtual dialogue host.

5. The method of claim 1, wherein the extracted information is unrelated to a functional business area of a company hosting the virtual dialogue host.

6. The method of claim 1, further comprising:
based on determining that the estimated wait time has elapsed, ending, by the computer, the extraction of information from the user.

7. The method of claim 2, wherein identifying the expertise of the user further comprises:
referencing, by the computer, an account associated with the user, one or more social media accounts associated with the user, or a professional certification website which includes the user.

8. A computer program product for crowdsourcing information, the computer program product comprising:
one or more computer-readable storage media and program instructions stored on the one or more computer-readable storage media, the program instructions comprising:
program instructions to detect a user contacting a virtual dialogue host which autonomously responds to user interaction;
program instructions to receive a query from the user;
program instructions to determine an estimated wait time to be connected to a representative;
program instructions to determine a complexity of information to be extracted from the user based on the estimated wait time, wherein a greater estimated wait time is associated with extracted information having a greater complexity;
program instructions to extract the information from the user during the estimated wait time; and
program instructions to aggregate the information extracted from the user.

9. The computer program product of claim 8, further comprising:
program instructions to identify an expertise associated with the user, and wherein the extracted information is related to the identified expertise of the user.

10. The computer program product of claim 8, further comprising:
program instructions to request additional information from the user which is related to the received user query based on a preprogrammed database correlating one or more user queries with requisite additional information; and
program instructions to receive the additional information from the user.

11. The computer program product of claim 8, wherein the extracted information is related to a functional business area of a company hosting the virtual dialogue host.

12. The computer program product of claim 8, wherein the extracted information is unrelated to a functional business area of a company hosting the virtual dialogue host.

13. The computer program product of claim 8, further comprising:
based on determining that the estimated wait time has elapsed, program instructions to end the extraction of information from the user.

14. The computer program product of claim 9, wherein identifying the expertise of the user further comprises:
program instructions to reference an account associated with the user, one or more social media accounts associated with the user, or a professional certification website which includes the user.

15. A computer system for crowdsourcing information, the computer system comprising:
one or more computer processors, one or more computer-readable storage media, and program instructions stored on one or more of the computer-readable storage media for execution by at least one of the one or more processors, the program instructions comprising:
program instructions to detect a user contacting a virtual dialogue host which autonomously responds to user interaction;
program instructions to receive a query from the user;
program instructions to determine an estimated wait time to be connected to a representative;
program instructions to determine a complexity of information to be extracted from the user based on the estimated wait time, wherein a greater estimated wait time is associated with extracted information having a greater complexity;
program instructions to extract the information from the user during the estimated wait time; and
program instructions to aggregate the information extracted from the user.

16. The computer system of claim 15, further comprising:
program instructions to identify an expertise associated with the user, and wherein the extracted information is related to the identified expertise of the user.

17. The computer system of claim 15, further comprising:
program instructions to request additional information from the user which is related to the received user query based on a preprogrammed database correlating one or more user queries with requisite additional information; and
program instructions to receive the additional information from the user.

18. The computer system of claim 15, wherein the extracted information is related to a functional business area of a company hosting the virtual dialogue host.

19. The computer system of claim 15, further comprising:
based on determining that the estimated wait time has elapsed, program instructions to end the extraction of information from the user.

20. The computer system of claim 16, wherein identifying the expertise of the user further comprises:
program instructions to reference an account associated with the user, one or more social media accounts associated with the user, or a professional certification website which includes the user.
